(19) United States
(12) Patent Application Publication
(10) Pub. No.: US 2004/0266227 A1
(43) Pub. Date: Dec. 30, 2004

(54) Electrical connector having electrical contacts with enlarged contact portions

(76) Inventor: Hao-Yun Ma, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/877,878

(22) Filed: Jun. 25, 2004

(30) Foreign Application Priority Data
Jun. 25, 2003 (TW) 92211559

(51) Int. Cl. H01R 12/00

(52) U.S. Cl. 439/71

(57) ABSTRACT

An electrical connector (10) includes an insulative housing (11), and a multiplicity of electrical contacts (12) received in the housing. Each contact comprises a retaining body (13) engagingly received in a corresponding passageway (110) of the housing, a soldering portion (14) extending from a bottom end of the retaining body for soldering to a PCB (40), and a resilient arm (16) extending from a lateral side of the retaining body. The resilient arm has a curved beam (162) extending slantingly upwardly and protrudes out from a top surface of the housing. An enlarged contact portion (164) is defined at a distal end of the curved beam. A width of the contact portion is substantially three times a width of the distal end of curved beam. The contact portion resiliently electrically contacts a metal contact pad of a CPU, thereby electrically connecting the CPU with the PCB.

### BACKGROUND OF THE INVENTION

1. Field of the Invention

The present invention relates to an electrical connector, and particularly to an electrical connector having a plurality of high elasticity electrical contacts for electrically connecting an electronic package such as a land grid array (LGA) central processing unit (CPU) with a circuit substrate such as a printed circuit board (PCB).

2. Description of the Prior Art

Electrical connectors are widely used in electrically connecting electronic packages such as land grid array (LGA) central processing units (CPUs) with circuit substrates such as printed circuit boards (PCBs). Pertinent examples of such electrical connectors are disclosed in U.S. Pat. Nos. 4,553,192 and 6,296,495.

Referring to FIGS. 8 and 9, a conventional electrical connector 9 connects a CPU 8 with a PCB 7. The connector 9 comprises an insulative housing 91, and a plurality of electrical contacts 92 (only one shown) received in the housing 91. The housing 91 defines a multiplicity of passageways 910 therethrough, for receiving a corresponding number of the contacts 92 therein.

Each contact 92 comprises a retaining body 920 engagingly received in a corresponding passageway 910, a soldering portion 921 extending from a bottom end of the retaining body 920, a connecting portion 922 extending from a lateral side of the retaining body 920, and a cantilever 924 extending slantingly upwardly from a top end of the connecting portion 922. The soldering portion 921 electrically connects with the PCB 7 via a solder ball 928. The cantilever 924 protrudes out from a top surface of the housing 91, and has a contact portion 926 at a distal end thereof for electrically contacting a corresponding metal contact pad 80 of the CPU 8. The connector 9 thus electrically connects the CPU 8 with the PCB 7.

The sizes of electrical connectors used in computers are steadily becoming smaller with the prevailing trend toward miniaturization of computers. In contrast, the number of contacts used in an electrical connector is increasing to meet the need for more signal transmission. Accordingly, the contact 92 may be fabricated to be miniaturized, with the contact portion 926 being correspondingly small. In such a connector 9, each contact 92 must be located exactly in its true position in the corresponding passageway 910, so as to ensure correct and reliable mechanical and electrical connectivity of the contact portion 926. This reduces tolerances of the connector 9, and makes manufacturing of the connector 9 more exacting and expensive. In addition, the connector 9 is typically inspected by a vision probe system (not shown) prior to marketing, to check for missing contacts 92. Because the contacts 92 are miniaturized, the vision probe system may not correctly ascertain whether each particular contact 92 is in fact in place in its corresponding passageway 910. This reduces the efficiency of manufacturing of the connector 9.

In view of the above, a new electrical connector that overcomes the above-mentioned disadvantages is desired.

### SUMMARY OF THE INVENTION

Accordingly, an object of the present invention is to provide a high-density electrical connector that has a plurality of electrical contacts reliably electrically connecting an electronic package such as a land grid array (LGA) central processing unit (CPU) with a circuit substrate such as a printed circuit board (PCB).

Another object of the present invention is to provide an electrical connector having a plurality of electrical contacts that are configured to facilitate accurate inspection by a vision probe system.

A further object of the present invention is to provide an electrical connector having a plurality of electrical contacts configured to enable the connector to be manufactured efficiently and inexpensively.

To fulfill the above-mentioned objects, an electrical connector in accordance with a preferred embodiment of the present invention comprises an insulative housing, and a plurality of electrical contacts received in the housing. The housing defines a multiplicity of passageways therethrough. Each contact comprises a retaining body engagingly received in a corresponding passageway of the housing, a soldering portion extending from a bottom end of the retaining body for soldering to a PCB, and a resilient arm extending from a lateral side of the retaining body. The resilient arm has a curved beam extending slantingly upwardly and protrudes out from a top surface of the housing. An enlarged contact portion is defined at a distal end of the curved beam. A width of the contact portion is substantially three times a width of the distal end of the curved beam. The contact portion resiliently electrically contacts a corresponding metal contact pad of a CPU, thereby electrically connecting the CPU with the PCB.

Other objects, advantages and novel features of the invention will become more apparent from the following detailed description when taken in conjunction with the accompanying drawings, in which:

### BRIEF DESCRIPTION OF THE DRAWINGS

FIG. 1 is an isometric view of an electrical contact of an electrical connector in accordance with the preferred embodiment of the present invention;

FIG. 2 is similar to FIG. 1, but viewed from another aspect;

FIG. 3 is a front elevation view of the contact of FIG. 1;

FIG. 4 is a side elevation view of the contact of FIG. 1;

FIG. 5 is a top elevation view of the contact of FIG. 1;

FIG. 6 is a cross-sectional view of part of the connector in accordance with the preferred embodiment of the present invention, showing a soldering portion of the contact of FIG. 1 connected with a corresponding part of a PCB via a solder ball, and a corresponding part of an LGA CPU above the connector ready to be connected with the contact;

FIG. 7 is similar to FIG. 6, but showing the LGA CPU connected with the contact;

FIG. 8 is an isometric view of an electrical contact of a conventional electrical connector; and

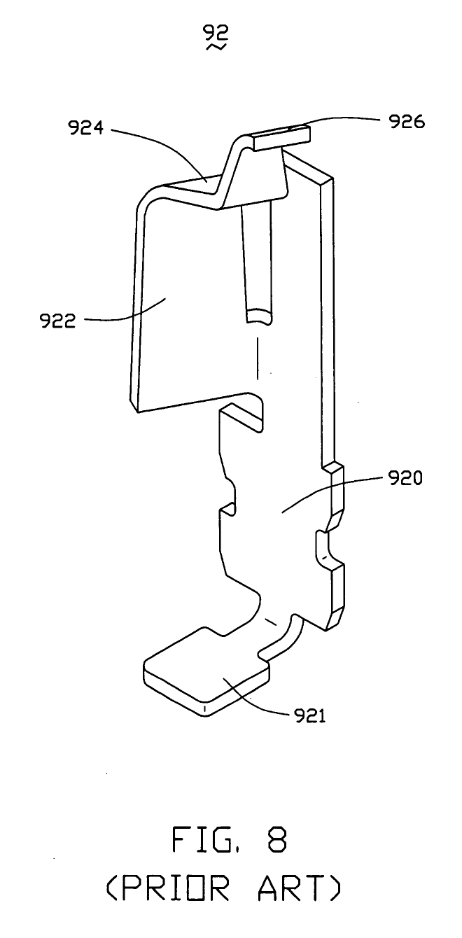

FIG. 9 is a cross-sectional view of part of said conventional connector, showing a soldering portion of the contact of FIG. 8 connected with a corresponding part of a PCB via a solder ball, and a corresponding part of an LGA CPU above the connector ready to be connected with the contact.

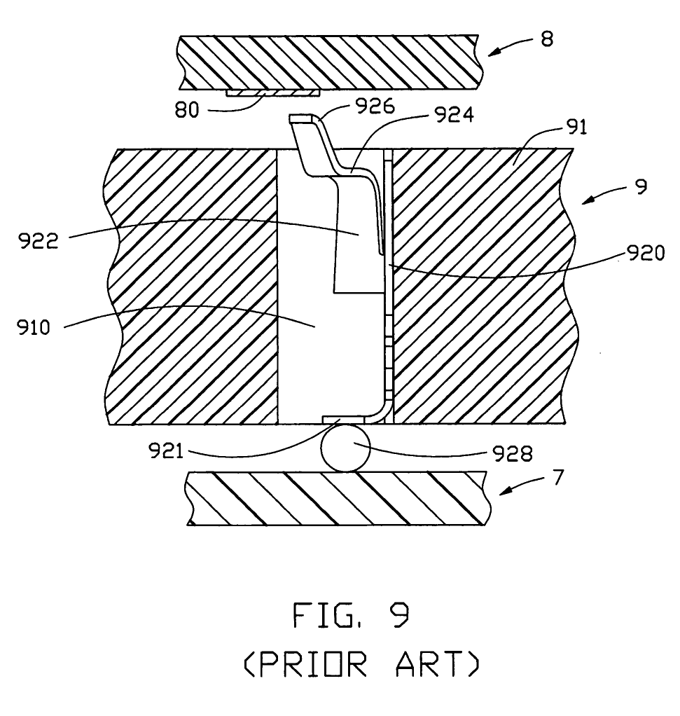

### DETAILED DESCRIPTION OF THE PREFERRED EMBODIMENT OF THE INVENTION

Reference will now be made to the drawings to describe the present invention in detail.

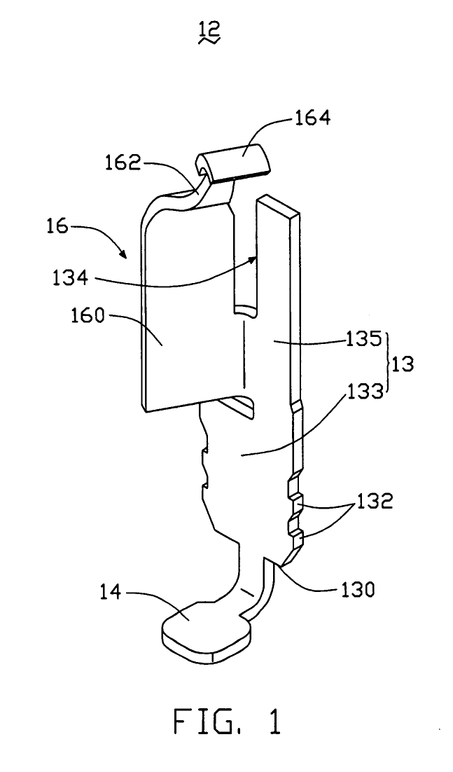

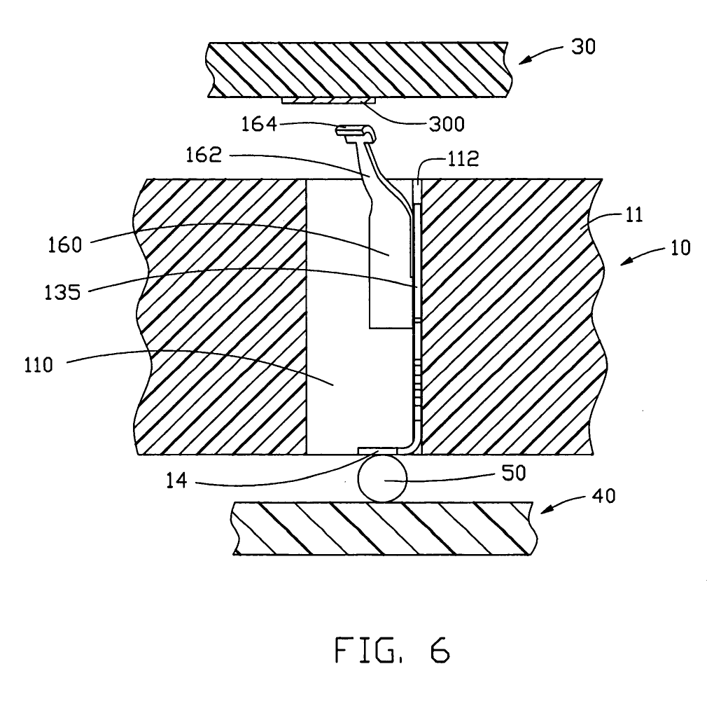

Referring to FIGS. 1 and 6, an electrical connector 10 in accordance with the preferred embodiment of the present invention is used for electrically connecting an electronic package such as a land grid array (LGA) central processing unit (CPU) 30 with a circuit substrate such as a printed circuit board (PCB) 40. The connector 10 comprises an insulative housing 11, and a plurality of electrical contacts 12 received in the housing 11. The housing 11 defines a multiplicity of passageways 110 therethrough, for receiving a corresponding number of the contacts 12 therein. Each passageway 110 has a slot 112 at an end thereof.

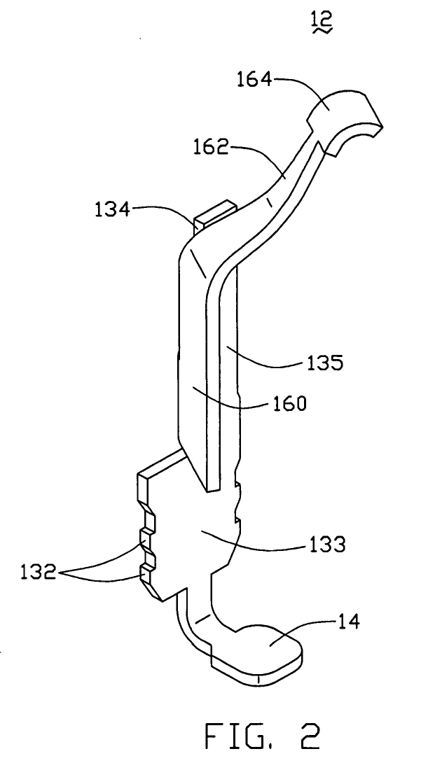

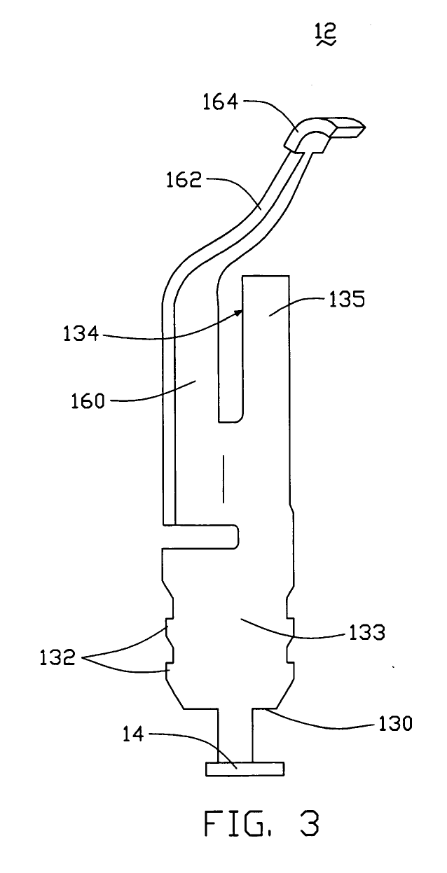

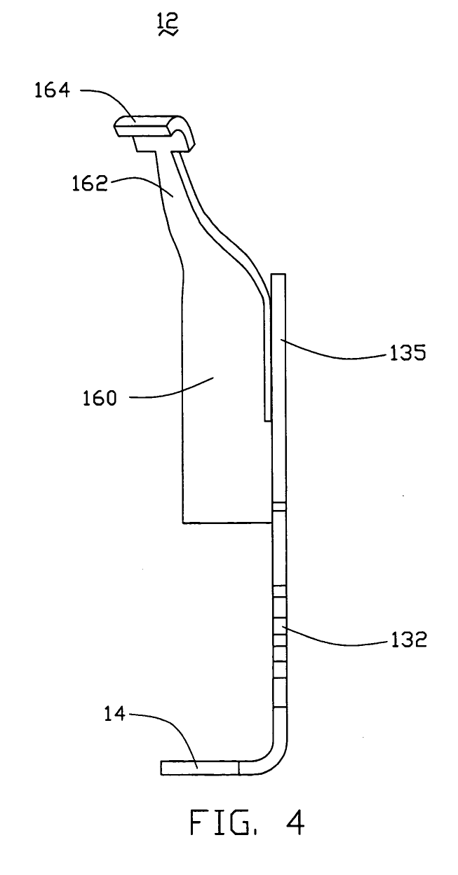

Referring to FIGS. 1 through 5, each contact 12 comprises a retaining body 13, a soldering portion 14 extending from a bottom end 130 of the retaining body 13, and a resilient arm 16 extending from a lateral side of the retaining body 13.

The retaining body 13 comprises a broad portion 133, and a narrow portion 135 extending from a top end of the broad portion 133. The broad portion 133 has a plurality of protrusions 132 at two lateral edges thereof. The protrusions 132 interferentially engage the housing 11 in the slot 112 of a corresponding passageway 110, such that the contact 12 is secured in the housing 11.

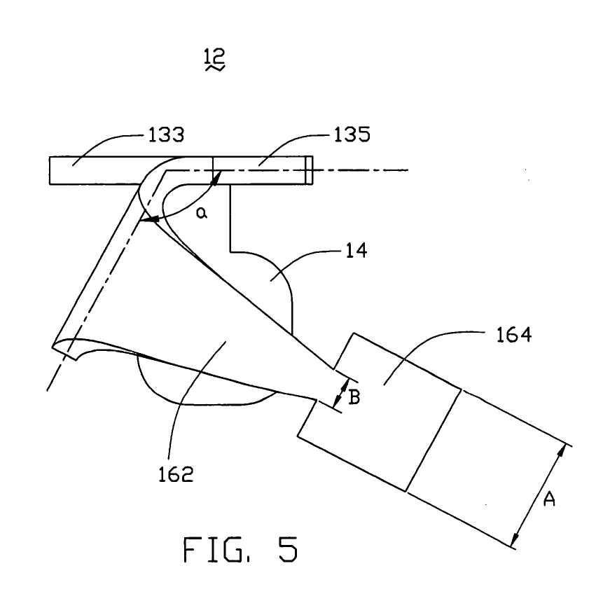

The resilient arm 16 comprises a body portion 160 extending from a lateral edge 134 of the narrow portion 135 of the retaining body 13, a curved beam 162 extending slantingly upwardly from a top end of the body portion 160, and an enlarged contact portion 164 defined at a distal end of the curved beam 162. An angle “a” (see FIG. 5) is formed between the body portion 160 of the resilient arm 16 and the narrow portion 135 of the retaining body 13, the angle “a” preferably being 135 degrees. The curved beam 162 tapers gradually from the body portion 160 to the contact portion 164, so that the curved beam 162 has enough elastic deformability. The distal end of the curved beam 162 has a width “B” (see FIG. 5), and the contact portion 164 of the contact 12 has a width “A.” The width A is preferably three times the width B.

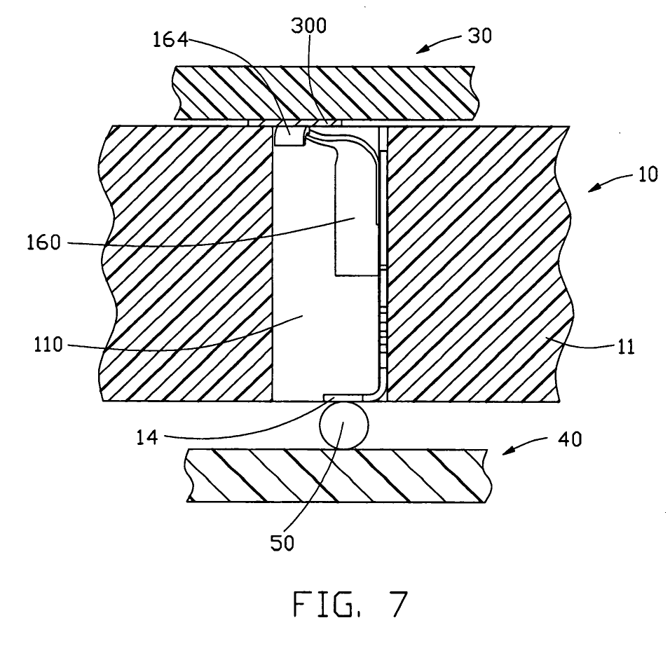

Referring to FIGS. 6 and 7, the soldering portion 14 of each contact 12 electrically connects with the PCB 40 via a solder ball 50. The curved beam 162 protrudes out from a top surface of the housing 11. When the CPU 30 is pressed down onto the top surface of the housing 11, the curved beam 162 deforms elastically down. The enlarged contact portion 164 reliably electrically contacts a corresponding metal contact pad 300 of the CPU 30. The connector 10 thus electrically connects the CPU 30 with the PCB 40.

Because the contact portion 164 is large, even when the contact 12 is not exactly oriented at a true position, the contact portion 164 can still reliably contact the metal contact pad 300 of the CPU 30. Similarly, if the contact portion 164 is not manufactured exactly according to its true specifications, it can still reliably contact the metal contact pad 300 of the CPU 30. These considerations increase tolerances of the connector 10, which makes manufacturing of the connector 10 easier and less expensive. Additionally, when the connector 10 is inspected by a vision probe system (not shown) for missing contacts 12 prior to marketing, the vision probe system can easily ascertain whether each particular contact 12 is in fact in place in its corresponding passageway 110. Thus, efficiency of manufacturing of the connector 10 is enhanced.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
an insulative housing defining a multiplicity of passageways therethrough; and
a plurality of electrical contacts received in the passageways respectively, each contact comprising a retaining body engagingly received in a corresponding passageway of the housing, a soldering portion extending from the retaining body, a resilient arm extending from a lateral side of the retaining body and protruding out from a top portion of the housing, and an enlarged contact portion defined at a distal end of the resilient arm, a width of the contact portion being greater than a width of the distal end of the resilient arm.

2. The electrical connector as claimed in claim 1, wherein the retaining body comprises a broad portion and a narrow portion extending from a top end of the broad portion, the resilient arm extending from a lateral edge of the narrow portion.

3. The electrical connector as claimed in claim 2, wherein the broad portion has a plurality of protrusions at two lateral edges thereof, the protrusions interferentially engaging in a corresponding passageway.

4. The electrical connector as claimed in claim 2, wherein the resilient arm comprises a body portion extending from a lateral edge of the narrow portion of the retaining body and a curved beam extending slantingly upwardly from a top end of the body portion, the contact portion defined at the distal end of the curved beam.

5. The electrical connector as claimed in claim 4, wherein the width of the contact portion is substantially three times the width of the distal end of the curved beam.

6. An electrical contact used in an electrical connector, comprising:
a retaining body securely received in the connector;
a soldering portion extending from the retaining body, the soldering portion adapted for electrically contacting a circuit substrate; and
a resilient arm extending from the retaining body, an enlarged contact portion defined at a distal end of the resilient arm, a width of the contact portion being substantially at least twice as great as a width of the distal end of the resilient arm, the contact portion protruding out from a top portion of the connector and adapted for resiliently electrically contacting an electronic package.

7. An electrical contact used in an electrical connector, comprising:
a retaining body securely received in a passageways of the connector;
a soldering portion extending from the retaining body, the soldering portion adapted for electrically contacting a circuit substrate; and
a resilient arm extending from the retaining body oblique to not only a plane defined by the retaining body but also a horizontal plane defined by a connector housing, an enlarged contact portion defined at a distal end of the resilient arm, the contact portion protruding out from a top portion of the connector and adapted for resiliently electrically contacting an electronic package; wherein
the enlarged contact portion is dimensioned small enough to be retreated into the corresponding passageway when depressed downwardly by the electronic package.
